(19) United States
(12) Patent Application Publication
(10) Pub. No.: US 2025/0358636 A1
(43) Pub. Date: Nov. 20, 2025

(54) INITIAL BEAM MANAGEMENT FOR NETWORK CONTROLLED REPEATER DEPLOYMENTS

(71) Applicant: Kyocera Corporation, Kyoto (JP)

(72) Inventors: Amit KALHAN, San Diego, CA (US); Masato FUJISHIRO, Yokohama (JP); Henry CHANG, San Diego, CA (US)

(21) Appl. No.: 18/871,394

(22) PCT Filed: Jul. 12, 2023
(86) PCT No.: PCT/US2023/027461

§ 371 Date: Dec. 3, 2024

Related U.S. Application Data
(60) Provisional application No. 63/388,739, filed on Jul. 13, 2022.

(51) Int. Cl. H04W 16/26; H04W 48/08

(52) U.S. Cl. CPC H04W 16/26; H04W 48/08

(57) ABSTRACT

A network transmits a Synchronization Signal Block (SSB) signal to a signal forwarding device via a first beam that is selected from a first set of beams utilized by the network to transmit the SSB signal. Each of the first set of beams is associated with an SSB index selected from a first set of SSB indices. The network also transmits SSB configuration information indicating a second set of beams that are available for the signal forwarding device to use to forward the SSB signal. Each of the second set of beams is associated with an SSB index selected from a second set of SSB indices. In response to receiving an indication that the forwarded SSB signal received at the UE device from the signal forwarding device is a preferred beam candidate, the network schedules transmissions for the UE device via the signal forwarding device.

### CLAIM OF PRIORITY

The present application claims priority to Provisional Application No. 63/388,739, entitled “INITIAL BEAM MANAGEMENT FOR NETWORK CONTROLLED REPEATER DEPLOYMENTS,” docket number TPRO 00375 US, filed Jul. 13, 2022, which is assigned to the assignee hereof and hereby expressly incorporated by reference in its entirety.

### FIELD

This invention generally relates to wireless communications and more particularly to managing an initial beam for communicating with a user equipment (UE) device.

### BACKGROUND

Beamforming is a traffic-signaling system for cellular base stations that identifies the most efficient spatial-directional delivery of data to a particular user equipment (UE) device while reducing interference for other, nearby UE devices. Beamforming involves focusing a signal in a concentrated beam that points in the direction of a particular UE device rather than broadcasting the signal in all directions at once.

### SUMMARY

The devices, systems, and methods described herein are directed towards a network transmitting a Synchronization Signal Block (SSB) signal to a signal forwarding device (e.g., NCR) via a first beam that is selected from a first set of beams utilized by the network to transmit the SSB signal. Each of the first set of beams is associated with an SSB index selected from a first set of SSB indices. The network also transmits SSB configuration information indicating a second set of beams that are available for the signal forwarding device to use to forward the SSB signal. Each of the second set of beams is associated with an SSB index selected from a second set of SSB indices. In response to receiving an indication that the forwarded SSB signal received at the UE device from the signal forwarding device is a preferred beam candidate, the network schedules transmissions for the UE device via the signal forwarding device.

### BRIEF DESCRIPTION OF THE DRAWINGS

FIG. 1A is a block diagram of an example of a system in which a base station of a network communicates with a user equipment (UE) device located at a particular angle and distance from the base station.

FIG. 1B is a block diagram of an example of a system in which a set of SSB indices that are available for a first signal forwarding device to use to forward the SSB signals is the same as one or more of the set of SSB indices that the base station utilizes to transmit the SSB signals.

FIG. 2A is a block diagram of an example of the base station shown in FIGS. 1A, 1B, 3, and 4.

FIG. 2B is a block diagram of an example of the user equipment devices shown in FIGS. 1A, 1B, 3, and 4.

FIG. 3 is a block diagram of an example of a system in which a set of SSB indices that are available for a first signal forwarding device to use to forward the SSB signals is different than the set of SSB indices that the base station utilizes to transmit the SSB signals.

FIG. 4 is a block diagram of an example of a system in which a set of SSB indices that are available for the first signal forwarding device to use to forward the SSB signals is the same as one or more of the set of SSB indices that the base station utilizes to transmit the SSB signals.

FIG. 5 is a flow chart of an example of a method performed at a network. The method includes transmitting, to a signal forwarding device, SSB signals and SSB configuration information. The method further includes scheduling transmissions for a UE device, via the signal forwarding device, in response to receiving an indication that a forwarded SSB signal received at the UE device from the signal forwarding device is a preferred beam candidate.

### DETAILED DESCRIPTION

A multiple-input, multiple-output (MIMO) base station uses multiple antennas to transmit signals to one or more intended user equipment (UE) devices. MIMO may also refer to a class of techniques for sending and receiving more than one data signal simultaneously over the same radio channel by exploiting multipath propagation.

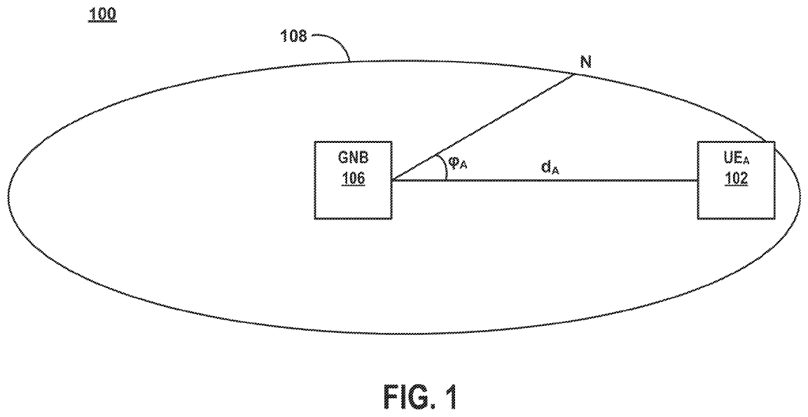

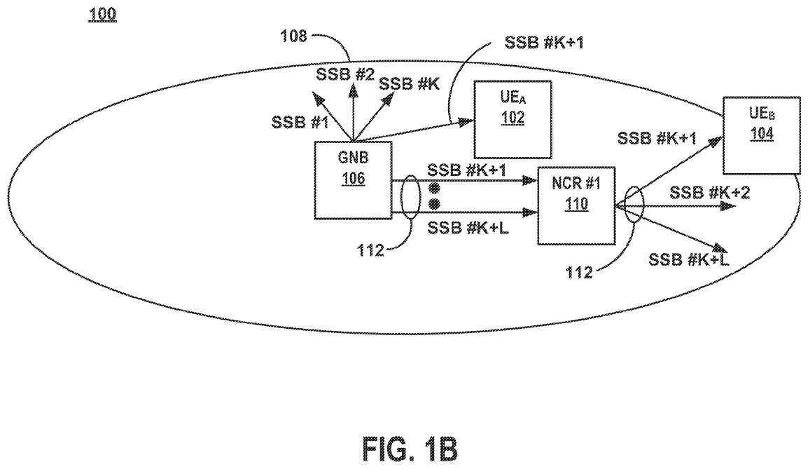

A MIMO base station uses narrow beams to transmit data to a particular UE device within the coverage area of the base station since higher frequency bands have high pathloss. FIG. 1A is a block diagram of an example of a system in which a base station communicates with a UE device located at a known angle and distance from the base station, which information can be utilized by the base station to form a beam to transmit data to the UE device. In the interest of brevity, FIG. 1A only depicts one UE device 102. However, any number of UE devices may be utilized, in other examples.

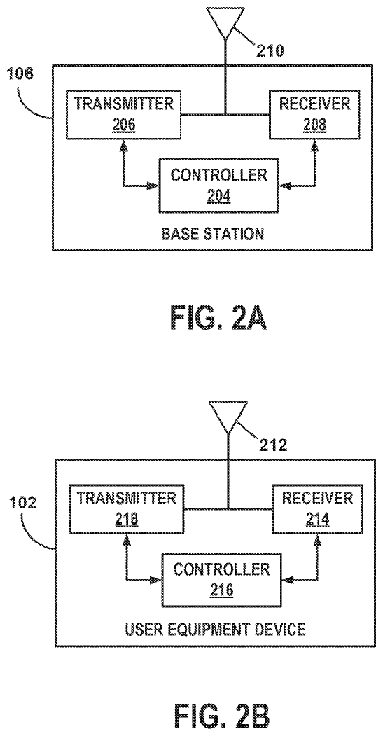

As shown in FIG. 2B, user equipment device (UE) 102 comprises controller 216, transmitter 218, receiver 214, and antenna 212, as well as other electronics, hardware, and software code. UE device 102 may also be referred to herein as a UE or as a wireless communication device (WCD). UE 102 is wirelessly connected to a radio access network (not shown) via base station 106, which provides various wireless services to UE 102. For the example shown in FIG. 1A, UE 102 operates in accordance with at least one revision of the 3rd Generation Partnership Project 5G New Radio (3GPP 5G NR) communication specification. In other examples, UE 102 may operate in accordance with other communication specifications. For the example shown in FIG. 1A, UE 102 has the same components, circuitry, and configuration as UE 102 from FIG. 2B. However, UE 102 in FIG. 1A may have components, circuitry, and configuration that differ from UE 102 in FIG. 2B, in other examples.

UE 102 is any fixed, mobile, or portable equipment that performs the functions described herein. The various functions and operations of the blocks described with reference to UE 102 may be implemented in any number of devices, circuits, or elements. Two or more of the functional blocks may be integrated in a single device, and the functions described as performed in any single device may be implemented over several devices.

Controller 216 includes any combination of hardware, software, and/or firmware for executing the functions described herein as well as facilitating the overall functionality of a user equipment device. An example of a suitable controller 216 includes software code running on a microprocessor or processor arrangement connected to memory. Transmitter 218 includes electronics configured to transmit wireless signals. In some situations, transmitter 218 may include multiple transmitters. Receiver 214 includes electronics configured to receive wireless signals. In some situations, receiver 214 may include multiple receivers. Receiver 214 and transmitter 218 receive and transmit signals, respectively, through antenna 212. Antenna 212 may include separate transmit and receive antennas. In some circumstances, antenna 212 may include multiple transmit and receive antennas.

Transmitter 218 and receiver 214 in the example of FIG. 2B perform radio frequency (RF) processing including modulation and demodulation. Receiver 214, therefore, may include components such as low noise amplifiers (LNAs) and filters. Transmitter 218 may include filters and amplifiers. Other components may include isolators, matching circuits, and other RF components. These components in combination or cooperation with other components perform the user equipment device functions. The required components may depend on the particular functionality required by the user equipment device.

Transmitter 218 includes a modulator (not shown), and receiver 214 includes a demodulator (not shown). The modulator can apply any one of a plurality of modulation orders to modulate the signals to be transmitted by transmitter 218. The demodulator demodulates received signals, in accordance with one of a plurality of modulation orders.

In the interest of clarity and brevity, only one base station is shown in FIG. 1A. However, in other examples, any suitable number of base stations may be utilized. In the example of FIG. 1A, base station 106 provides wireless services to UEs within coverage area 108. Although not explicitly shown, coverage area 108 may be comprised of multiple cells. For the example shown in FIG. 1A, base station 106, sometimes referred to as a gNodeB or gNB, can receive uplink messages from UE devices and can transmit downlink messages to the UE devices.

Base station 106 is connected to the network through a backhaul (not shown) in accordance with known techniques. As shown in FIG. 2A, base station 106 comprises controller 204, transmitter 206, receiver 208, and antenna 210 as well as other electronics, hardware, and code. Base station 106 is any fixed, mobile, or portable equipment that performs the functions described herein. The various functions and operations of the blocks described with reference to base station 106 may be implemented in any number of devices, circuits, or elements. Two or more of the functional blocks may be integrated in a single device, and the functions described as performed in any single device may be implemented over several devices.

For the example shown in FIG. 2A, base station 106 may be a fixed device or apparatus that is installed at a particular location at the time of system deployment. Examples of such equipment include fixed base stations or fixed transceiver stations. In some situations, base station 106 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, base station 106 may be a portable device that is not fixed to any particular location. Accordingly, base station 106 may be a portable user device such as a UE device in some circumstances.

Controller 204 includes any combination of hardware, software, and/or firmware for executing the functions described herein as well as facilitating the overall functionality of base station 106. An example of a suitable controller 204 includes code running on a microprocessor or processor arrangement connected to memory. Transmitter 206 includes electronics configured to transmit wireless signals. In some situations, transmitter 206 may include multiple transmitters. Receiver 208 includes electronics configured to receive wireless signals. In some situations, receiver 208 may include multiple receivers. Receiver 208 and transmitter 206 receive and transmit signals, respectively, through antenna 210. Antenna 210 may include separate transmit and receive antennas. In some circumstances, antenna 210 may include multiple transmit and receive antennas.

Transmitter 206 and receiver 208 in the example of FIG. 2A perform radio frequency (RF) processing including modulation and demodulation. Receiver 208, therefore, may include components such as low noise amplifiers (LNAs) and filters. Transmitter 206 may include filters and amplifiers. Other components may include isolators, matching circuits, and other RF components. These components in combination or cooperation with other components perform the base station functions. The required components may depend on the particular functionality required by the base station.

Transmitter 206 includes a modulator (not shown), and receiver 208 includes a demodulator (not shown). The modulator modulates the signals that will be transmitted and can apply any one of a plurality of modulation orders. The demodulator demodulates any uplink signals received at base station 106 in accordance with one of a plurality of modulation orders.

As shown in the example of FIG. 1A, system 100 includes base station 106 having coverage area 108. UE device 102 (e.g., UE_{A}) is located in coverage area 108. More specifically, UE device 102 is located along an angle, φ_{A}, and at a distance, d_{A}, from base station 106. In the example shown in FIG. 1A, the angle φ_{A} is the horizontal angle (e.g., azimuth) from a cardinal direction (e.g., north). In other examples, the angle φ_{A} may be determined relative to any other suitable reference direction. As described more fully below, a beam sweeping operation may be utilized to determine the optimal beam for base station 106 to transmit a Synchronization Signal Block (SSB) signal to UE device 102, which in FIG. 1A appears to be the beam that corresponds with angle, φ_{A}, from base station 106. The SSB signal may be transmitted with a transmit power that is based on the distance between UE device 102 and base station 106.

Since a narrow beam can only reach a small portion of the coverage area at a given time, the base station performs a beam sweeping operation to reach the different parts of the coverage area. Similarly, the UE device within the coverage area of the base station also performs its own sweeping operation to determine the best link to communicate with the base station. The UE device obtains the best link when the transmitting and the receiving beam pair is optimal for the UE device at a particular time. Depending upon the number of beams and the coverage area size, the beam sweeping operation can be time consuming. In practice, the beam sweeping operation takes several iterations, starting with an initial sub-optimal beam pair. After exchanging further channel state information (CSI) between the base station and the UE device, a beam refinement process is performed until the optimal transmitting and receiving beam pair are determined.

In the 3GPP 5G NR communication specification, the base station transmits an SSB signal during the beam sweeping procedure using one beam in one direction and then transmits the next SSB block to a different direction using a different beam and so on. Each SSB signal is transmitted with an SSB index (e.g. identifier) to facilitate identification of the beam on which that particular SSB signal was transmitted. The SSB signal is repeatedly transmitted to a different direction using a different beam until the SSB signal is effectively transmitted to all portions of the coverage area. This burst of SSB transmissions is repeated with a fixed periodicity (e.g., time interval) known to the UE devices located in the coverage area of the base station.

A UE device that receives the SSB transmissions performs beam strength measurements on each of the received SSB transmissions. Based on a comparison of the beam strength measurements, the UE device transmits a report to the base station including the SSB index (or indices) of the best candidate beam(s). The report from the UE device enables the base station to determine the best direction to apply for transmissions to and from the reporting UE device.

A radio frequency (RF) repeater is a network node that performs an amplify-and-forward (A&F) operation on signals that are received from a donor base station (e.g., gNB). While an RF repeater presents a cost-effective means of extending network coverage, RF repeaters have limitations. For example, an RF repeater simply performs an A&F operation without being able to consider various factors that could improve performance. Such factors may include information on semi-static and/or dynamic downlink/uplink configuration, adaptive transmitter/receiver spatial beamforming, ON-OFF status, etc.

A network-controlled repeater (NCR) is an enhancement over conventional RF repeaters and has the capability to receive and process side control information from the network. Side control information may allow an NCR to perform an A&F operation in a more efficient manner. For example, an NCR could use side control information to mitigate unnecessary noise amplification, transmit and receive signals with better spatial directivity, and simplify network integration.

To achieve simplicity and backward compatibility, the NCR is transparent to the UE devices. Thus, in some examples, during the initial beam acquisition the NCR performs an A&F operation on an assigned set of SSB transmissions. Therefore, in these examples, the gNB assigns a first set of SSB indices to an NCR (e.g., #K+1, K+2, . . . , K+L) and transmits SSB signals towards the NCR utilizing the first set of SSB indices.

The NCR performs an A&F operation on the SSB signals received from the gNB. In performing the A&F operation, the NCR transmits (e.g., forwards) the SSB signals with the assigned first set of SSB indices, each forwarded SSB signal transmitted in a different direction from the NCR to reach all of the different parts of the coverage area of the NCR. However, such a configuration can cause problems.

For example, consider the situation shown in FIG. 1B in which (1) UE device A 102 is located in a coverage area 108 of the gNB 106 and receives SSB signals from the gNB 106, (2) UE device B 104 is located in a coverage area of NCR #1, 110 and receives SSB signals from NCR #1, 110, and (3) the gNB 106 and NCR #1, 110 transmit their respective SSB signals utilizing at least some of the same set 112 of SSB indices (e.g., #K+1, K+2, . . . , K+L). The problem occurs when both UE device A 102 and UE device B 104 report the same SSB index (e.g., #K+1) as their best beam candidate to the gNB 106. Based on the reported SSB index, the gNB 106 is unable to determine whether any of the reporting UE devices 102, 104 are located within the coverage area of the NCR. This is problematic since the gNB 106 must be able to reliably determine that UE device B 104 is in the coverage area of NCR #1, 110 so that the gNB 106 can send data for UE device B 104 to be relayed/forwarded via NCR #1, 110. Thus, there is a need for a solution to this problem. The devices, systems, and methods described below may advantageously allow a network to schedule data transmissions for UE devices within a coverage area of an NCR.

For example, the devices, systems, and methods described herein are directed towards a network transmitting an SSB signal to a signal forwarding device (e.g., NCR) via a first beam that is selected from a first set of beams utilized by the network to transmit the SSB signal. Each of the first set of beams is associated with an SSB index selected from a first set of SSB indices. The network also transmits SSB configuration information indicating a second set of beams that are available for the signal forwarding device to use to forward the SSB signal. Each of the second set of beams is associated with an SSB index selected from a second set of SSB indices. In response to receiving an indication that the forwarded SSB signal received at the UE device from the signal forwarding device is a preferred beam candidate, the network schedules transmissions for the UE device via the signal forwarding device.

In some examples, the second set of SSB indices is different than the first set of SSB indices. In other examples in which the second set of SSB indices is the same as one or more of the first set of SSB indices, the network may transmit SSB signals via the first set of beams during a first time period that is different than a second time period during which the signal forwarding device forwards the SSB signal via the second set of beams. In still further examples, the network may select a timing and/or frequency resources to transmit SSB signals such that the SSB signal transmissions do not interfere with the signal forwarding device forwarding the SSB signals.

Although the different examples described herein may be discussed separately, any of the features of any of the examples may be added to, omitted from, or combined with any other example. Similarly, any of the features of any of the examples may be performed in parallel or performed in a different manner/order than that described or shown herein.

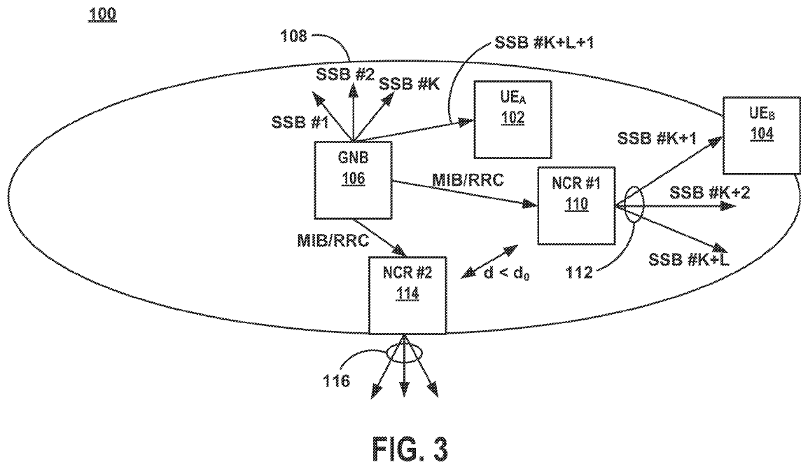

In operation, a network transmits, to a signal forwarding device, an SSB signal via a first beam that is selected from a first set of beams utilized by the network to transmit the SSB signal. Each of the first set of beams is associated with an SSB index selected from a first set of SSB indices. The network also transmits, to the signal forwarding device, SSB configuration information indicating a second set of beams that are available for the signal forwarding device to use to forward the SSB signal. Each of the second set of beams is associated with an SSB index selected from a second set of SSB indices. An example of this configuration is shown in FIG. 3, in which base station 106 performs at least part of the functionality of the network.

In some examples, base station 106 performs all of the network functionality described herein (e.g., transmitting SSB signals, transmitting SSB configuration information, receiving an indication regarding the preferred beam candidate, and scheduling transmissions for UE devices via signal forwarding devices). In other examples, base station 106 may perform some of the network functionality described herein, and one or more other base stations or components of the network may perform one or more other network functions.

In the example shown in FIG. 3, network-controlled repeaters (e.g., NCR #1, 110 and NCR #2, 114) are utilized as signal forwarding devices. However, in other examples, an Intelligent Reflecting Surface (IRS) may be utilized as a signal forwarding device.

In some examples, NCRs are located at or near the edge of a coverage area of a gNB. Therefore, in these examples, SSB transmissions from base station 106 are less likely to interfere with the SSB transmissions from NCR #1, 110, as received at UE device B 104. However, in other examples, the SSB transmissions from base station 106 could cause interference to UE devices served by an NCR. To avoid such a situation, base station 106 could refrain from transmitting SSB signals when the NCR is transmitting/forwarding the SSB signals and/or transmit SSB signals in a different set of frequency resources or sub-bands than those being utilized by the NCR, in some examples.

FIG. 3 shows base station 106 of a network transmitting, to NCR #1, 110, an SSB signal via a first beam that is selected from a first set of beams utilized by the network to transmit the SSB signal. Each of the first set of beams is associated with an SSB index selected from a first set of SSB indices. Base station 106 also transmits, to NCR #1, 110, SSB configuration information indicating a second set of beams that are available for NCR #1, 110 to use to forward the SSB signal. Each of the second set of beams is associated with an SSB index selected from a second set of SSB indices. In some examples, base station 106 may receive, from NCR #1, 110, a request for a particular number of SSB indices to be included in the second set of SSB indices. In these examples, base station 106 may include the requested number of SSB indices in the second set of SSB indices in the SSB configuration information.

In some examples, the SSB configuration information indicates a set of resources NCR #1, 110 is allowed to use to forward the SSB signal. More specifically, base station 106 may indicate which SSB indices and which SSB resources NCR #1, 110 is allowed to use. For the example of FIG. 3, base station 106 configures NCR #1, 110 with SSB indices #K+1 to #K+L. For the SSB resources, base station 106 configures NCR #1, 110 with a bitmap for available resources within a group and another bitmap for group presence and periodicity (e.g., similar to ssb-PositionsInBurst and ssb-periodicityServingCell information).

In some examples, the second set of SSB indices is different than the first set of SSB indices. FIG. 3 shows an example of a system in which a set of SSB indices that are available for a first signal forwarding device to use to forward the SSB signals is different than the set of SSB indices that the base station utilizes to transmit the SSB signals. More specifically, FIG. 3 shows that base station 106 transmits, to NCR #1, 110, SSB configuration information indicating a second set of SSB indices (e.g., #K+1, K+2, . . . , K+L) that are available for NCR #1, 110 to use when forwarding the SSB signal. Thus, in the example shown in FIG. 3, the second set of SSB indices (e.g., #K+1, K+2, . . . , K+L) is different than the first set of SSB indices (e.g., #1, #2, #K, #K+L+1).

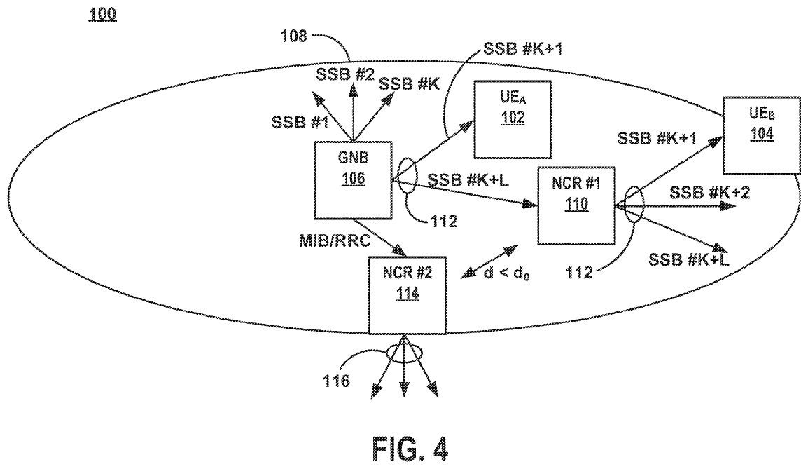

In some examples, base station 106 transmits the SSB configuration information to NCR #1, 110 via an SSB signal that includes a Master Information Block (MIB) message, which includes Radio Resource Control (RRC) parameters. In other examples, base station 106 explicitly configures NCR #1, 110 with the RRC parameters. These alternative methods of base station 106 configuring the NCRs with the appropriate SSB configuration information is represented in FIGS. 3 and 4 with the “MIB/RRC” label on signal transmissions from base station 106 to the NCRs.

Utilizing the SSB configuration information received from base station 106, NCR #1, 110 generates its SSB signals with the allowed SSB indices and transmits them within the allowed SSB resources. In some examples, NCR #1, 110 tunes the beam weights for each SSB signal, based on the number of SSBs NCR #1, 110 is allowed to use, to send the broadcast information to all the portions of the coverage area of NCR #1, 110.

Applying the example of FIG. 3, UE device A 102 receives, from base station 106, an SSB signal having SSB index #K+L+1, and UE device B 104 receives, from NCR #1, 110, a forwarded SSB signal having SSB index #K+1. Upon receipt of their respective SSB signals, UE device A 102 and UE device B 104 determine their respective preferred beam candidate(s). Assuming the preferred beam candidate for UE device A 102 is the SSB signal having SSB index #K+L+1, UE device A 102 transmits, to base station 106, an indication (e.g., report) that the SSB signal having SSB index #K+L+1 is a preferred beam candidate. Assuming the preferred beam candidate for UE device B 104 is the SSB signal having SSB index #K+1, UE device B 104 transmits, to base station 106, an indication (e.g., report) that the forwarded SSB signal having SSB index #K+1 is a preferred beam candidate. In some examples, the report from UE device B 104 is forwarded to base station 106 by NCR #1, 110. In other examples, the report from UE device B 104 is transmitted directly to base station 106.

Since the second set of SSB indices (e.g., #K+1, K+2, . . . , K+L) have been assigned to NCR #1, 110, base station 106 determines that UE device B 104 is in the coverage area of NCR #1, 110 and that UE device A 102 is within its own coverage area 108. Thus, in response to receiving the indication that the forwarded SSB signal received at UE device B 104 from NCR #1, 110 is a preferred beam candidate, base station 106 utilizes its controller 204 to schedule transmissions for UE device B 104 via NCR #1, 110, in some examples. In other examples, a network entity other than the base station that received the report from the UE device (e.g., another base station) may be used to schedule the downlink/uplink data transmissions for UE device B 104 via NCR #1, 110. Regardless of which network entity performs the scheduling, the network transmits scheduling information to NCR #1, 110 to schedule transmissions via NCR #1, 110 for UE device B 104.

FIG. 3 also shows an example in which a distance between a first signal forwarding device and a second signal forwarding device is below a threshold distance. More specifically, the example of FIG. 3 shows that the set 112 of SSB indices available for NCR #1, 110 to use when forwarding SSB signals is different than the set 116 of SSB indices available for NCR #2, 114 to use when forwarding SSB signals. Each of the SSB indices in the set 116 of SSB indices is associated with a beam selected from a set of beams that are available for NCR #2, 114 to use to forward the SSB signals when a distance, d, between NCR #1, 110 and NCR #2, 114 is below a minimum threshold distance, d₀ (e.g., d<d₀). In other examples where the distance between neighboring NCRs is greater than or equal to the minimum threshold distance (e.g., d≥d₀), it can be presumed that the transmissions from the NCRs will not interfere with each other.

In the foregoing examples, different sets of SSB indices are utilized by a base station and one or more signal forwarding devices to facilitate a determination of whether the UE devices are within a coverage area of the base station or within a coverage area of a particular signal forwarding device. In other examples, the second set of beams that are available for a signal forwarding device to use to forward the SSB signal is the same as one or more of the first set of SSB indices utilized by a base station to transmit the SSB signals. An example of such configuration is shown in FIG. 4.

More specifically, FIG. 4 is a block diagram of an example of a system in which a set of SSB indices that are available for a signal forwarding device to use to forward the SSB signals is the same as one or more of the set of SSB indices that the base station utilizes to transmit the SSB signals. For example, FIG. 4 shows that the set of SSB indices (e.g., #K+1, K+2, . . . , K+L) that are available for NCR #1, 110 to use to forward SSB signals is the same as a sub-set of the SSB indices that base station 106 utilizes to transmit the SSB signals. More specifically, in the example shown in FIG. 4, the SSB indices that base station 106 utilizes to transmit SSB signals include #1, #2, . . . #K, #K+1, K+2, . . . , K+L. Thus, the set of SSB indices (e.g., #K+1, K+2, . . . , K+L) that NCR #1, 110 uses to forward SSB signals is a sub-set of the SSB indices that base station 106 utilizes to transmit the SSB signals.

In order to differentiate between transmissions from base station 106 and NCR #1, 110, base station 106 utilizes its transmitter 206 to transmit SSB signals via the first set of beams during a first time period that is different than a second time period during which NCR #1, 110 transmits (e.g., forwards) the SSB signal via the second set of beams. The network can utilize information received in the report from the UE device to determine which base station or NCR transmitted/forwarded the SSB signal that is the preferred beam candidate for the reporting UE device. In addition to the SSB index, the information may include timing information and/or frequency resource information associated with the SSB signal transmission that is the preferred beam candidate for the reporting UE device.

In other examples, assume the periodicity of an SSB burst set transmitted from base station 106 consists of a number, L, of SSBs is 80 ms, since L<<Lₘₐₓ, the first burst set can be completed in 20 ms, and the time-shifted burst set from base station 106 can start after 20 ms, using one or more of the same SSB indices assigned to NCR #1, 110. Each of these SSB burst sets from base station 106 can repeat with the same 80 ms periodicity. The network can determine the preferred beam candidate indicated by the UE devices, by noting the SSB index (e.g. based on the Random Access Channel (RACH) resource selected) as well as the time-shift indicated in the report received from the UE device (e.g., when the RACH was sent). This configuration advantageously allows use of the narrow beam width designed for high frequency bands in 3GPP 5G NR (e.g., FR2).

In examples utilizing FR2, the number of SSB indices is much higher (e.g., Lₘₐₓ=64), which is needed to create narrower beams so that the increased number of beams will cover a similar area during beam sweeping compared to low frequency bands in 3GPP 5G NR (e.g., FR1). However, in these scenarios, NCR #1, 110 is only assigned a sub-set of the SSB indices, assuming the same Lₘₐₓ number of SSBs are available, meaning that wider beam widths are used to cover a similar coverage area.

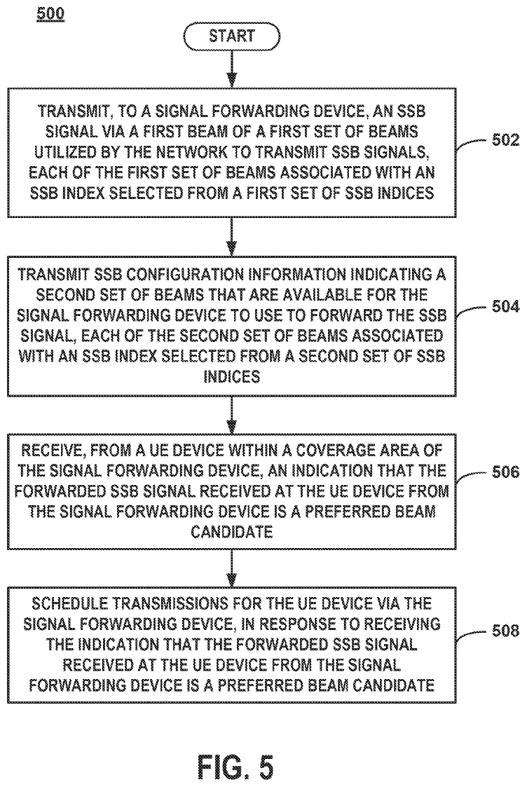

FIG. 5 is a flow chart of an example of a method performed at a network. The method includes transmitting, to a signal forwarding device, SSB signals and SSB configuration information. The method further includes scheduling transmissions for a UE device, via the signal forwarding device, in response to receiving an indication that a forwarded SSB signal received at the UE device from the signal forwarding device is a preferred beam candidate. At step 502, a network transmits, to a signal forwarding device, an SSB signal via a first beam of a first set of beams utilized by the network to transmit SSB signals. Each of the first set of beams is associated with an SSB index selected from a first set of SSB indices.

At step 504, the network transmits SSB configuration information indicating a second set of beams that are available for the signal forwarding device to use to forward the SSB signal. Each of the second set of beams is associated with an SSB index selected from a second set of SSB indices. At step 506, the network receives, from a UE device within a coverage area of the signal forwarding device, an indication that the forwarded SSB signal received at the UE device from the signal forwarding device is a preferred beam candidate. At step 508, the network schedules transmissions for the UE device via the signal forwarding device, in response to receiving the indication that the forwarded SSB signal received at the UE device from the signal forwarding device is a preferred beam candidate.

In other examples, one or more of the steps of method 500 may be omitted, combined, performed in parallel, or performed in a different order than that described herein or shown in FIG. 5. In still further examples, additional steps may be added to method 500 that are not explicitly described in connection with the example shown in FIG. 5.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A network comprising:
a transmitter configured to transmit, to a first signal forwarding device:
a Synchronization Signal Block (SSB) signal via a first beam that is selected from a first set of beams utilized by the network to transmit the SSB signal, each of the first set of beams associated with an SSB index selected from a first set of SSB indices, and
SSB configuration information indicating a second set of beams that are available for the first signal forwarding device to use to forward the SSB signal, each of the second set of beams associated with an SSB index selected from a second set of SSB indices;
a receiver configured to receive, from a user equipment (UE) device within a coverage area of the first signal forwarding device, an indication that the forwarded SSB signal received at the UE device from the first signal forwarding device is a preferred beam candidate; and
a controller configured to schedule transmissions for the UE device via the first signal forwarding device, in response to receiving the indication that the forwarded SSB signal received at the UE device from the first signal forwarding device is a preferred beam candidate.

2. The network of claim 1, wherein the second set of SSB indices is different than the first set of SSB indices.

3. The network of claim 1, wherein the second set of SSB indices is different than a third set of SSB indices, each of the third set of SSB indices associated with a beam selected from a third set of beams that are available for a second signal forwarding device to use to forward the SSB signal when a distance between the first signal forwarding device and the second signal forwarding device is below a threshold distance.

4. The network of claim 1, wherein the second set of SSB indices is the same as one or more of the first set of SSB indices.

5. The network of claim 4, wherein the transmitter is further configured to transmit SSB signals via the first set of beams during a first time period that is different than a second time period during which the first signal forwarding device forwards the SSB signal via the second set of beams.

6. The network of claim 1, wherein the transmitter is further configured to refrain from transmitting SSB signals when the first signal forwarding device is forwarding the SSB signal.

7. The network of claim 1, wherein the transmitter is further configured to transmit SSB signals using first frequency resources that are different than second frequency resources used by the first signal forwarding device to forward the SSB signal.

8. The network of claim 1, wherein the SSB configuration information indicates a set of resources the first signal forwarding device is allowed to use to forward the SSB signal.

9. The network of claim 1, wherein the receiver is further configured to receive, from the first signal forwarding device, a request for a particular number of SSB indices to be included in the second set of SSB indices.

10. A signal forwarding device comprising:
a receiver configured to receive, from a network:
a Synchronization Signal Block (SSB) signal via a first beam that is selected from a first set of beams utilized by the network to transmit the SSB signal, each of the first set of beams associated with an SSB index selected from a first set of SSB indices, and
SSB configuration information indicating a second set of beams that are available for the signal forwarding device to use to forward the SSB signal, each of the second set of beams associated with an SSB index selected from a second set of SSB indices; and
a transmitter configured to forward the SSB signal to a user equipment (UE) device within a coverage area of the signal forwarding device,
the receiver further configured to receive, from the network, scheduling information to schedule transmissions via the signal forwarding device for the UE device, the scheduling information sent in response to the network receiving an indication that the forwarded SSB signal received at the UE device from the signal forwarding device is a preferred beam candidate.

11. The signal forwarding device of claim 10, wherein the second set of SSB indices is different than the first set of SSB indices.

12. The signal forwarding device of claim 10, wherein the second set of SSB indices is different than a third set of SSB indices, each of the third set of SSB indices associated with a beam selected from a third set of beams that are available for a second signal forwarding device to use to forward the SSB signal when a distance between the signal forwarding device and the second signal forwarding device is below a threshold distance.

13. The signal forwarding device of claim 10, wherein the second set of SSB indices is the same as one or more of the first set of SSB indices.

14. The signal forwarding device of claim 13, wherein the transmitter is further configured to forward the SSB signal via the second set of beams during a first time period that is different than a second time period during which the network transmits SSB signals via the first set of beams.

15. The signal forwarding device of claim 10, wherein the network refrains from transmitting SSB signals when the signal forwarding device is forwarding the SSB signal.

16. The signal forwarding device of claim 10, wherein the transmitter is further configured to forward the SSB signal using first frequency resources that are different than second frequency resources used by the network to transmit SSB signals.

17. The signal forwarding device of claim 10, wherein the SSB configuration information indicates a set of resources the signal forwarding device is allowed to use to forward SSB signals.

18. The signal forwarding device of claim 10, wherein the transmitter is further configured to transmit, to the network, a request for a particular number of SSB indices to be included in the second set of SSB indices.

19. The signal forwarding device of claim 10, wherein the signal forwarding device is a network-controlled repeater (NCR).

20. The signal forwarding device of claim 10, wherein the signal forwarding device is an Intelligent Reflecting Surface (IRS).
